(19) United States
(12) Patent Application Publication
(10) Pub. No.: US 2003/0030244 A1
(43) Pub. Date: Feb. 13, 2003

(54) Apparatus for propelling a wheelchair

(75) Inventor: Dong-Sun Choi, Kwangju (KR)

Correspondence Address: Ajay A. Jagtiani, JAGTIANI & GUTTAG, Democracy Square Business Center, 10379 B Democracy Lane, Fairfax, VA, 22030, US

(73) Assignee: Dong-Sun Choi, Kwangju (KR)

(21) Appl. No.: 10/121,950

(22) Filed: Apr. 12, 2002

(30) Foreign Application Priority Data
Aug. 13, 2001 PCT/KR01/01377
Aug. 7, 2001 (KR) 10-2001-0047398

(51) Int. Cl. B62M 1/04

(52) U.S. Cl. 280/252

(57) ABSTRACT

The present invention discloses an apparatus for propelling the wheelchair that prevents a backward movement and helps the occupant rotate the wheel with less manual torque. The invention makes it possible for the disabled person to climb the sloped road with less manual force and without fear of dangerous backward slide.

### FIELD OF THE INVENTION

The present invention relates to a wheelchair, more in particular, to an apparatus for powering a wheelchair. More specifically, this invention relates to a wheelchair having a hand-operable powering device, allowing the occupant to propel the drive wheel with less torque and even to climb the sloped road easily.

### BACKGROUND OF THE INVENTION

Wheelchairs typically consist of a chair frame disposed between two sets of rear and front wheels. The rear wheel, which acts as the drive wheel, is engaged directly by the occupant's hands to propel the chair.

The disabled occupant sits on the wheelchair and moves wherever he wants to go by propelling the ring that is mounted about the same axis of rotation as the drive wheel.

For instance, U.S. Pat. Nos. 6,112,837 and 6,095,747 disclose techniques to implement a wheelchair for the disabled person.

In the meanwhile, there is a shortcoming in the traditional wheelchair especially when the disabled occupant tries to climb the sloped road since he needs to supply more torque for propelling the wheel by his arms.

Furthermore, it is even more difficult to cross over a bump with a slope for the disabled occupant since the wheelchair tends to move backward due to the slope of the bump.

### BRIEF SUMMARY OF THE INVENTION

In view of these problems, there is a need in the art for a wheelchair that is not subject to these limitations.

Accordingly, it is an object of the present invention to provide an apparatus for propelling the wheelchair such that the disabled person sitting on the wheelchair easily propels the wheel with less manual torque even when he climbs the sloped road.

It is further an object of the present invention to provide an apparatus for propelling the wheelchair such that the disabled person sitting on the wheelchair avoids the unintentional backward movement of the chair due to the slope of a road or a bump.

In accordance with a broad aspect of the present invention, provided is an apparatus for propelling the wheelchair.

The apparatus for propelling the wheelchair comprises a multiple of pulleys with wires for reducing the level of torque that is manually provided by the disabled person and clamps for rotating the wheel without the backward movement.

### BRIEF DESCRIPTION OF THE DRAWINGS

Further features of the present invention will become apparent from a description of the wheelchair with the propelling apparatus, taken in conjunction with the accompanying drawings of the preferred embodiment of the invention, which, however, should not be taken to be limitative to the invention, but are for explanation and understanding only.

In the drawings:

FIG. 1 is a schematic bird's-eye-view illustrating a preferred embodiment of the apparatus for propelling the wheelchair in accordance with the present invention.

FIG. 2 is a schematic side-view illustrating a preferred embodiment of the apparatus for propelling the wheelchair in accordance with the present invention.

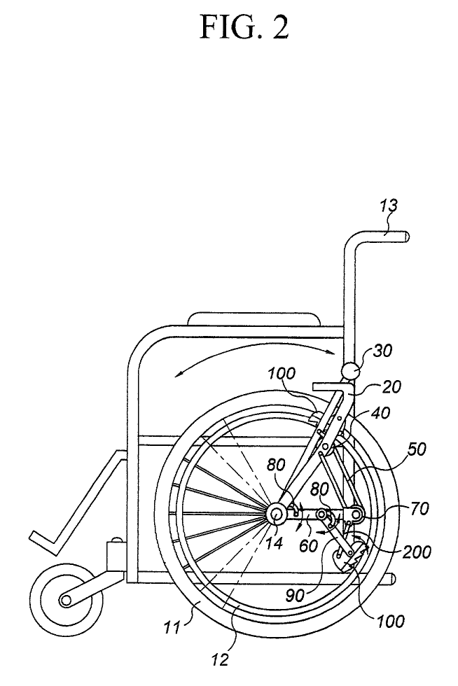

FIG. 3 is a schematic plan-view illustrating a preferred embodiment of the apparatus for propelling the wheelchair in accordance with the present invention.

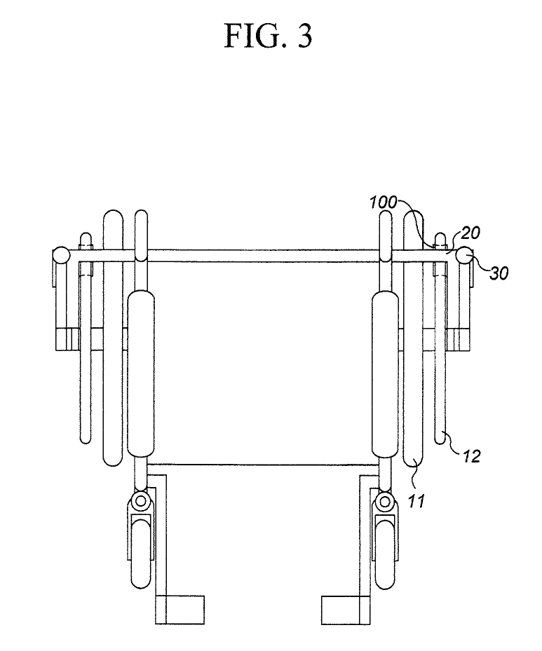

FIG. 4 is a schematic front-view illustrating a preferred embodiment of the apparatus for propelling the wheelchair in accordance with the present invention.

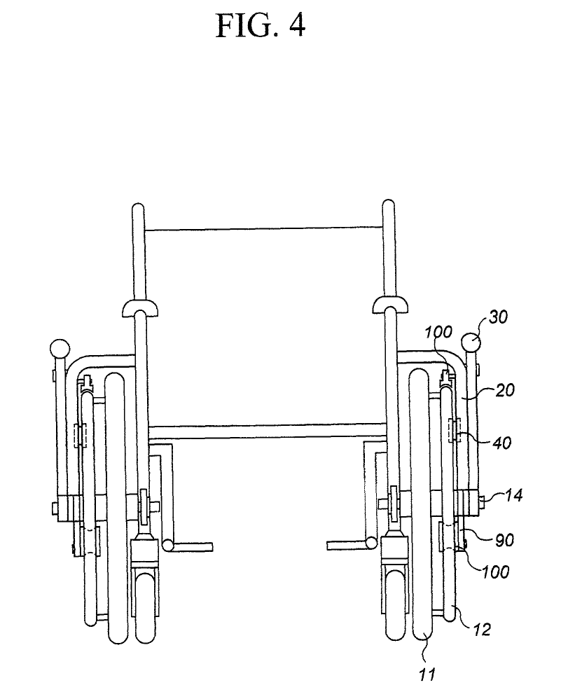

FIG. 5 is a schematic diagram illustrating the magnified side-view of the apparatus for propelling the wheelchair in accordance with the present invention.

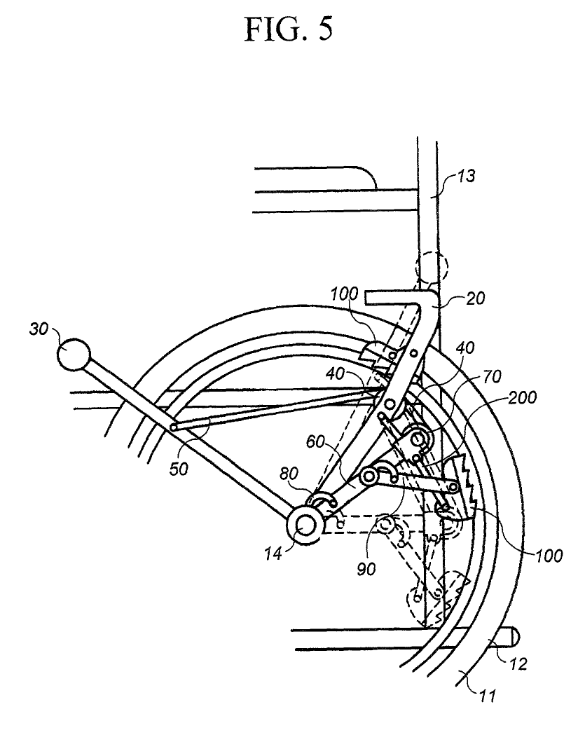

FIG. 6 is a schematic diagram illustrating the clamp comprising the apparatus for propelling the wheelchair in accordance with the present invention.

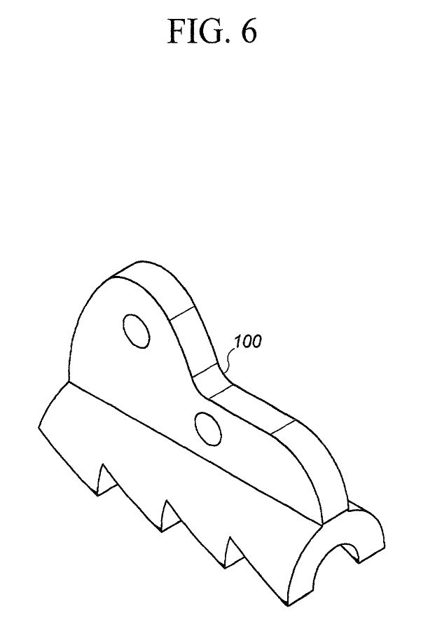

### DETAILED DESCRIPTION OF THE INVENTION

Preferred embodiments in accordance with the present invention will be explained in detail with reference to the accompanying drawings.

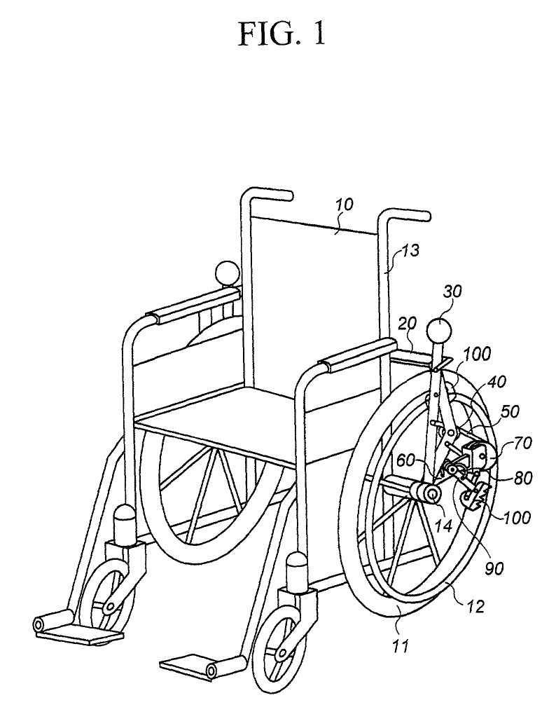

FIG. 1 is a schematic diagram illustrating the propelling apparatus for the wheelchair in accordance with the present invention.

The apparatus for propelling the wheelchair comprises a first roller 40 and a holding frame 20 for the central axis wherein one end is aligned with the central axis 14 of the wheel and the other end is assembled with a body handler 13 of the wheelchair.

Further, one end of the lever 30 is inserted and assembled with the axis 14 of the wheel in such a way that the lever 30 moves back and forth along the circle with the axis 14.

One end of a holding frame 60 for a second roller 70 is also tied to the central axis 14 for the circular movement.

The holding frame 60 for a second roller 70 is also tied to a holding frame 90 for a clamp 100.

The one side of the holding frame 20 for the central axis now acts as a hinge. The clamp 100 is implemented in a slanted manner such that the clamp touches the handle 12 and experiences the frictional force against the handle 12 when the handle 12 of the wheelchair moves backward.

A first wire 50 is installed such that the first wire 50 is fixed to one end of the lever 30 in contact with a first roller 40 and simultaneously to the holding frame 20 for the central axis.

A second wire 200 is installed such that the second wire 200 is fixed to one end of the holding frame 90 for the clamp 100 and simultaneously to the backside of the clamp 100.

As a preferred embodiment in accordance with the present invention, a restoring material 80 can be applied such that the holding frame 60 for a second roller and the holding frame 90 for the clamp recover to the original position after the displacement.

When the occupant sitting on the chair wants to climb the sloped road, he pushes the lever 30. Then a second roller 70 moves in the same direction with the lever 30 through a first wire 50.

As a consequence of the simultaneous movement of the holding frame 60 of a second roller, the clamp 100, which is fixed by a second wire 200, moves and becomes in contact with the handle 12 of the wheelchair.

In this case, the holding frame 90 for the clamp 100 moves together with the holing frame 60 for a second roller. Consequently, the clamp 100 exerts a force on the handle and makes the handle 12 rotate.

After a pre-defined amount of movement of the holding frame 60 for a second roller and holding frame 90 for clamp, they moves back to their initial position. Simultaneously, the lever is positioned at the original position via a first wire 50 due to a restoring material comprising at one side of the holding frame 90 of the clamp.

As a preferred embodiment of a restoring material in accordance with the present invention, a spring can be employed.

As the clamp 100 installed at the holding frame 90 gets off from the handle 12, the handle 12 of the wheelchair tends to rotate in a backward direction.

The clamp 100 prepared at one side of holding frame 20 of the central axis prevents the wheel from rotating in a backward direction because the clamp 100 is geared to the handle 12 of the wheelchair and is implemented in a slanted fashion with reference to the front direction.

Furthermore, the restoring material installed at one end of the holding frame 90 exerts a restoring force on the clamp 100 and thereby prevents the wheel from rotating in a backward direction.

Thereby, it becomes possible to lower the torque that occupant has to exert on the wheel by implementing a multiple number of rollers and wires comprising a pulley system as a propulsion device for a wheelchair.

It also becomes possible to prevent the wheelchair from dangerously sliding in a backward direction on a sloped road through a clamp exerting a frictional force on the handler due to the restoring force in accordance with the present invention.

Although the invention has been illustrated and described with respect to exemplary embodiments thereof, it should be understood by those skilled in the art that various other changes, omissions and additions may be made therein and thereto, without departing from the spirit and scope of the present invention.

Therefore, the present invention should not be understood as limited to the specific embodiment set forth above but to include all possible embodiments which can be embodies within a scope encompassed and equivalents thereof with respect to the feature set forth in the appended claims.

What is claimed is:

1. An apparatus for propelling a wheelchair, the apparatus comprising:
a lever with a predetermined length moving in a circular motion with respect to a central axis as a hinge;
a holding frame for a central axis with a first roller at a predefined location, tied at one side of said lever, and tied at the central axis of the wheelchair;
a clamp with a saw-tooth shaped rubber exerting a frictional force on the handle of the wheelchair, formed at one of the holding frame of the central axis;
a holding frame for a second roller having a second roller at one end, moving with the central axis as a hinge;
a holding frame for said clamp exerting a force on said handle of the wheelchair, moving with one end of said holding frame for a second roller as a hinge;
a first wire connecting said lever and said first roller, winding said second roller, fixed at one of said holding frame for the central axis, and moving said holding frame for said second roller when the lever is pushed;
a second wire tied to one end of said clamp, fixed at one end of said holding frame of said second roller, and moving said clamp when said holding frame for said second roller moves;
a holding frame for said second roller; and
a restoring material installed at one end of said holding frame for said clamp.

2. The apparatus as set forth in claim 1, wherein said first roller, said second roller, and said holding frame for said second roller further comprises a multiple of pulleys.

3. The apparatus as set forth in claim 1, wherein said restoring material comprises a spring and prevents the wheelchair from moving backward through a restoring force exerted on the wheel.
